(19) United States
(12) Patent Application Publication
(10) Pub. No.: US 2026/0313529 A1
(43) Pub. Date: Oct. 8, 2026

(54) Slice-based Public Land Mobile Network (PLMN) Selection in Wireless Communication

(71) Applicant: Apple Inc., Cupertino, CA (US)

(72) Inventors: Vivek G. Gupta, San Jose, CA (US); Haijing Hu, Los Gatos, CA (US)

(21) Appl. No.: 19/482,464

(22) PCT Filed: May 9, 2024
(86) PCT No.: PCT/US2024/028546

§ 371 Date: Nov. 7, 2025

Related U.S. Application Data
(60) Provisional application No. 63/501,431, filed on May 11, 2023.

(51) Int. Cl. H04W 48/18; H04W 8/06; H04W 64/00

(52) U.S. Cl. CPC H04W 48/18; H04W 8/06; H04W 64/003

(57) ABSTRACT

Methods, systems, and devices for slice-based Public Land Mobile Network (PLMN) selection in Wireless Communications are described. One method includes determining if enhanced slice information is available in a roaming scenario. If the enhanced slice information is available, a slice-based PLMN selection is performed to select a slice of a first PLMN. If the enhanced slice information is not available, anon-slice-based PLMN selection is performed to select a second PLMN.

### FIELD

The present application relates to wireless devices and wireless networks, including systems, devices, circuits, and methods for slice-based Public Land Mobile Network (PLMN) selection in wireless communication.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

Recently, 5G technologies have introduced the concept of network slicing, which provides multiple network slices that a user equipment (UE) may access for different services and/or applications. For example, individual network slices could be established for enhanced Mobile Broadband (eMBB), Ultra-Reliable and Low Latency Communications (URLLC), Internet of Things (IoT), and/or vehicle to everything (V2X) communications.

The connection to a PLMN is governed by the UE subscription, the availability of the network services, as well as the signal strength (and, hence, location/Tracking Area (TA) of the UE). As part of the Enhanced Access to and Support of Network Slice (EASNS) development, it is desired that a roaming UE activating a service (and/or application) that requires a network slice that is not offered by the serving network has the ability to access such services if the services are available from other networks in the area. To that end, a Home-PLMN (HPLMN) should provide the UE with prioritization information of Visiting-PLMNs (VPLMNs) to which the UE may register for such a network slice.

However, the specific UE behaviors for receiving network slice information and selecting a PLMN are not established. More specifically, how the new enhanced slice availability interacts with legacy prioritized PLMNs is not well-defined. Furthermore, if a UE wants to use more than one network slice, there may be conflicting enhanced slice information from different PLMNs that could lead to the UE being denied the best slice/service by selecting a PLMN that does not provide the most desirable slice/service, but rather provides another “subscribed” slice for the UE.

Given these various deficiencies, there is a need to establish UE and network behavior for selecting an appropriate network slice when multiple PLMNs are available.

### SUMMARY

In one aspect, embodiments relate to a method for PLMN selection that includes determining if enhanced slice information is available. When the enhanced slice information is available, a slice-based PLMN selection is performed to select a slice of a first PLMN. When the enhanced slice information is not available, a non-slice-based PLMN selection is performed to select a second PLMN. Wireless communication is performed using the selected PLMN.

In another aspect, embodiments relate to a method for slice-based PLMN selection that includes obtaining enhanced slice information with available slices from a network and generating a prioritized list of the available slices. The method includes determining if a prioritized list of available PLMNs is available. If the prioritized list of available PLMNs is available, a highest priority PLMN of the available PLMNs is selected for a most preferred slice or slices of the available slices. If the prioritized list of available PLMNs is not available, a prioritized list of PLMNs for each available slice is generated and a highest priority PLMN from the prioritized list of PLMNs for a most preferred slice or slices is selected from the prioritized list of the available slices.

The techniques described herein may be implemented in and/or used with a number of different types of devices, including but not limited to cellular phones, wireless devices, tablet computers, wearable computing devices, portable media players, Internet of Things (IoT) devices, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates a communication device, according to some aspects.

FIG. 3 illustrates an example block diagram of a Base Station (BS), according to some aspects.

FIGS. 4A and 4B illustrate processes for slice-based PLMN selection, according to some aspects.

FIG. 5 illustrates a process for PLMN selection, according to some aspects.

FIGS. 6A and 6B illustrate methods for network selection, according to some aspects.

FIGS. 7A and 7B provide examples of how the enhanced slice information may be organized on a Universal Subscriber Identity Module (USIM), according to some aspects.

FIGS. 8A, 8B, 8C, and 8D illustrate examples of how Steering of Roaming-Enhanced Slice Information (SoR-ESI) information may be stored/presented to the UE, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

For EASNS development, a HPLMN will provide a UE with a preferred list of PLMNs for each network slice-based on the UE subscription. The UE performs the PLMN selection based on the received information. The HPLMN may update this information subsequently upon changes in UE subscription or based on other HPLMN triggers. However, conflicts may still arise if priorities of different work slices of the PLMNs are not considered.

For example, a network slice is uniquely identified by Single-Network Slice Selection Assistance Information (S-NSSAI). A UE may desire to use slices S-NSSAI-1 and S-NSSAI-2, with S-NSSAI-2 being preferred by the UE over S-NSSAI-1. The PLMN selection may list the available PLMNs in the prioritized order: PLMN A, PLMN B, PLMN, C, and PLMN D. If S-NSSAI-1 is available on PLMN C and PLMN A and S-NSSAI-2 is available on PLMN D and PLMN B, the UE may be conflicted because the highest priority PLMN (PLMN-A) does not include the most desired S-NSSAI (S-NSSAI-2). Furthermore, a specific PLMN may still contain pockets areas (i.e., TAs) that may not support a specific S-NSSAI (e.g., a partially rejected S-NSSAI or partially allowed S-NSSAI). Given these and other conditions, the UE could end up not using the highest priority PLMN or not getting the desired service through preferred network slice.

Accordingly, in general, embodiments disclosed herein are directed selecting an appropriate PLMN in the event of additional slice information and VPLMN information. Embodiments help establish what information about prioritized VPLMNs is transferred from network to UE that may be used for PLMN selection based on slice information. Embodiments also help define when this information about prioritized VPLMNs is transferred from network to UE. Embodiments further help define assistance information, if necessary, that may be transferred from the UE to the network to assist the network in creating a list of prioritized VPLMNs. Embodiments disclosed herein also establish the UE behavior upon the reception of enhanced slice information for the PLMN selection.

Further embodiments describe how a PLMN search may be triggered when different network slices are available, as well as PLMN selection in different scenarios, such as during power on, intersystem change, periodic search timer expiry, etc. A PLMN search may also be triggered based on a UE's need, such as a need for a specific network service or connection characteristics for different services/applications. Such a need may be triggered, for example, by starting an application. Embodiments further consider the interaction with legacy networks, e.g., EPS/4G/3G/2G that may not include such network slicing.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. £ Examples include FPGAS (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” or “mobile station” (MS) or “mobile equipment” (ME) may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e. g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

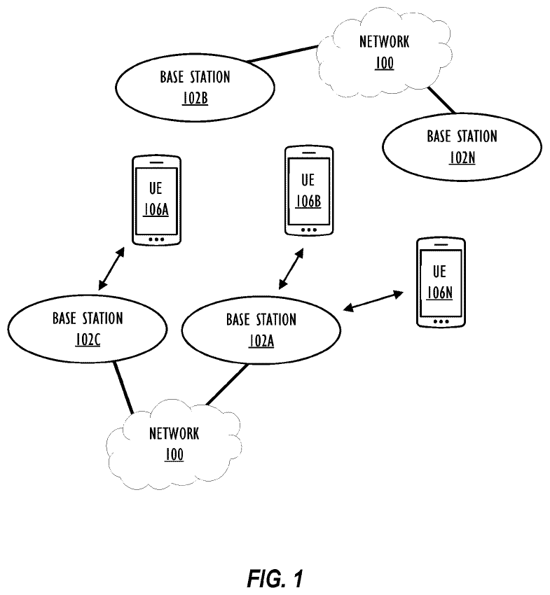

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2CDMA2000 . Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a side link (SL) interface for direct communications between devices. The IoT UEs may also execute background applications (e.g., keep-alive messages, status updates, and the like) to facilitate the connections of the IoT network.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more TRPs. In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e. g., Bluetooth, Wi-Fi peer-to-peer, and the like) in addition to at least one of the cellular communication protocols discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device. Embodiments may also include vehicles, industrial equipment, or other devices that may benefit from multi-panel wireless connectivity.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a BB processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

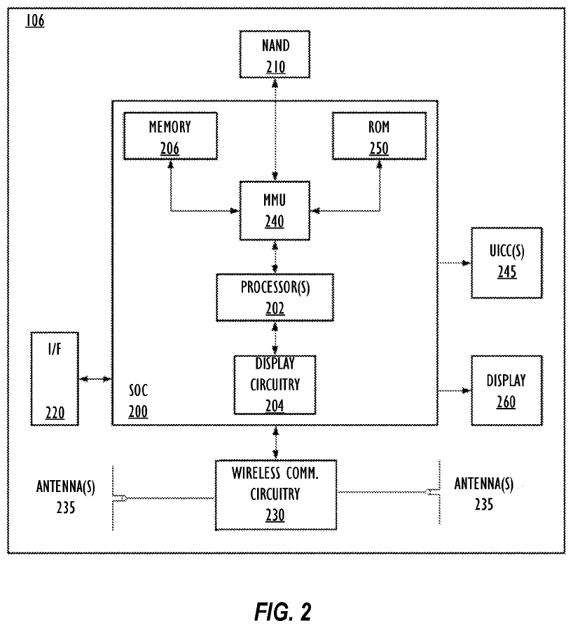

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and the wireless communication circuitry 230 may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e. g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

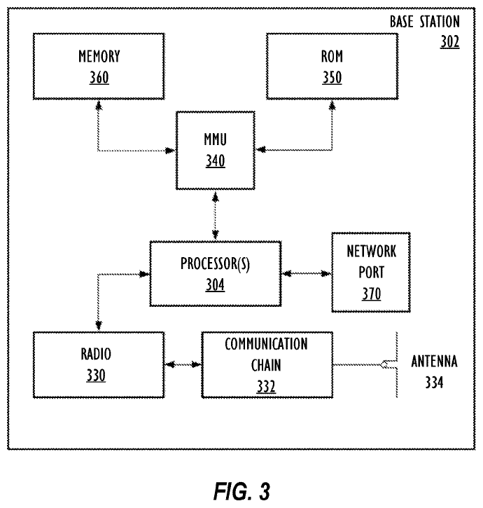

FIG. 3 illustrates an example block diagram of a base station 302, according to some aspects. It is noted that the base station of FIG. 3 is a non-limiting example of a possible base station. As shown, the base station 302 may include processor(s) 304 which may execute program instructions for the base station 302. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 302 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 302 may be a next generation base station, (e.g., a 5G New Radio (5G NR) base station, or “gNB”). In such aspects, base station 302 may be connected to a legacy evolved packet core (EPC) network and/or to a NR core (NRC) / 5G core (5GC) network. In addition, base station 302 may be considered a 5G NR cell and may include one or more transition and reception points (TRPs). In addition, a UE capable of operating according to 5G NR may be connected to one or more TRPs within one or more gNBs.

The base station 302 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 302 may be configured to communicate wirelessly using multiple wireless communication standards. In some instances, the base station 302 may include multiple radios, which may enable the base station 302 to communicate according to multiple wireless communication technologies. For example, as one possibility, the base station 302 may include an LTE radio for performing communication according to LTE as well as a 5G NR radio for performing communication according to 5G NR. In such a case, the base station 302 may be capable of operating as both an LTE base station and a 5G NR base station. When the base station 302 supports mmWave, the 5G NR radio may be coupled to one or more mmWave antenna arrays or panels. As another possibility, the base station 302 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 302 may include hardware and software components for implementing or supporting implementation of features described herein. The processor 304 of the base station 302 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 302, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

In accordance with embodiments disclosed herein, a UE evaluates network broadcasted cells in order to connect to a network. For example, a UE starts the connection process after being powered on, during recovery from the loss of a network connection, by request from the UE, or even periodically in the background.

The UE determines the broadcast cell selection criteria, such as the signal level and other quality criteria. The cells that meet the quality criteria are then considered for connection. For example, cells with a signal level greater than 85 dBm for Global System for Mobiles (GSM); greater than 95 dBm for Universal Mobile Telecommunications System (UMTS) Terrestrial Radio Access Network (UTRAN) Frequency Division Duplex (FDD); greater than 84 dBm for UTRAN Time Division Duplex (TDD); and greater than 110 dBm for LTE, NB-Iot and Nr.

The cells that meet the selection criteria may then be supplied to the network. The UE may provide a list of cells that meet the selection criteria to the Non-Access Stratum (NAS) in the UE. The list may also include the measurements, such as signal level/quality, associated with one or more of the cells.

Armed with the cells that meet the signal selection criteria, the availability of enhanced slice information associated with the cells helps determine the PLMN/slice selection process. In embodiments disclosed herein, if enhanced slice information is available on the Universal Subscriber Identity Module (USIM) or on the ME, the UE performs slice-based PLMN selection. In this context, the UE can be considered the ME plus the USIM.

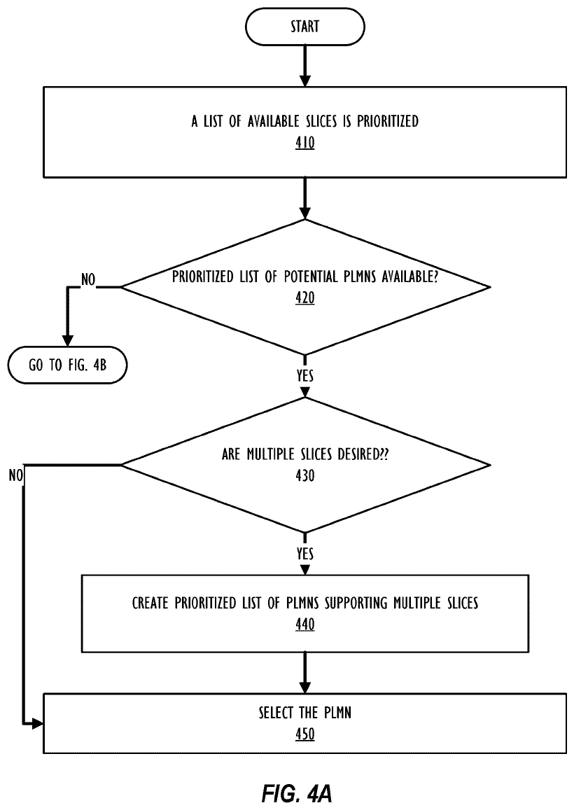

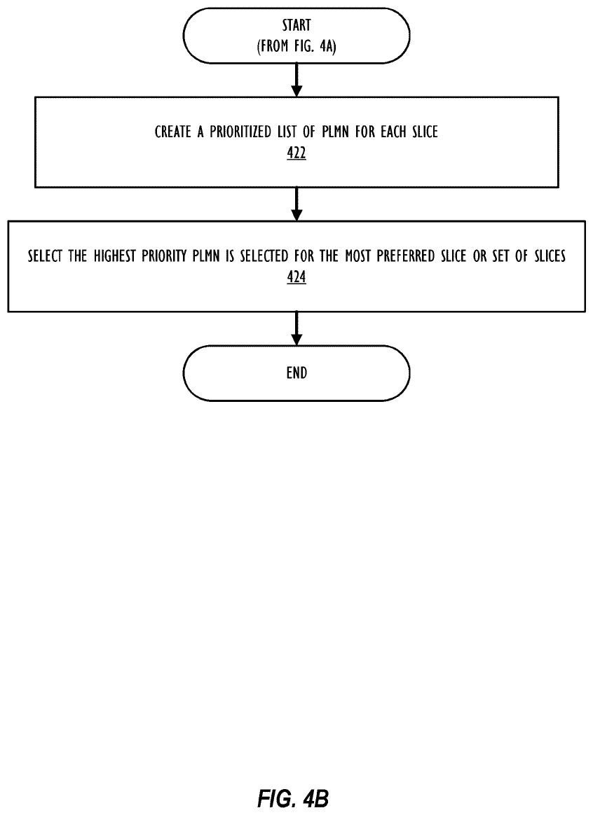

Turning now to FIG. 4A, a process for slice-based PLMN selection is illustrated in flowchart form, in accordance with some aspects. In step 410, if the enhanced slice information is available, the UE prioritizes the list of available slices. The list may be prioritized based on the UE preference, UE Route Selection Policy (URSP), and/or the active applications. In Step 420, it is determined if a prioritized list of available PLMNs for each slice is available.

If a prioritized list of available PLMNs for each slice is available (YES in Step 420), the process determines if multiple slices are desired in Step 430. If multiple slices are desired (YES in Step 430), a prioritized list of PLMNs supporting the multiple slices may be created in Step 440. That is, if the UE is interested in multiple slices, the UE may create a list of VPLMNs supporting the multiple slices. In Step 450, the UE selects the appropriate PLMN. From the list of Step 440, the UE may select the highest priority VPLMN based on the priority assigned by the HPLMN. The priority assigned by the HPLMN may be included as part of the enhanced slice information, or otherwise transmitted to the UE.

If multiple slices are not desired (NO in Step 430), the process proceeds to Step 530, where the UE selects the appropriate PLMN. In this step, the UE may select the highest priority VPLMN for the most preferred slice of the UE (when the HPLMN has the prioritized list of available VPLMNs for each slice).

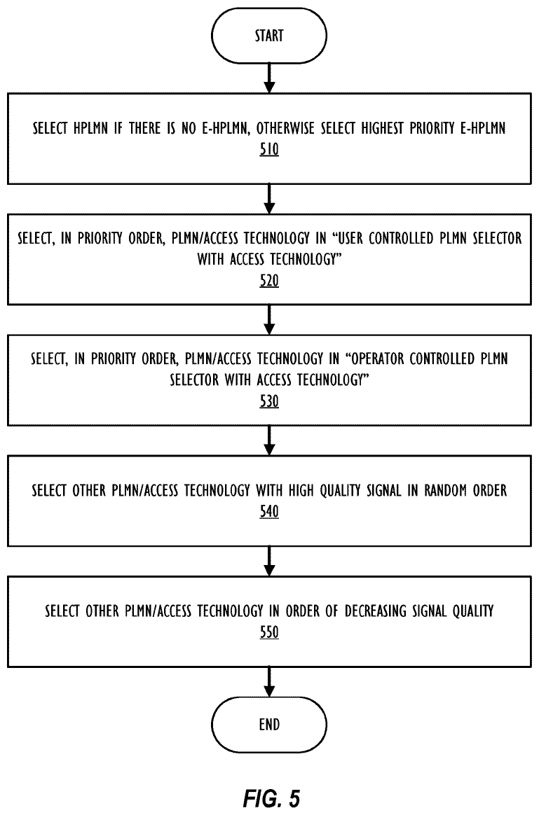

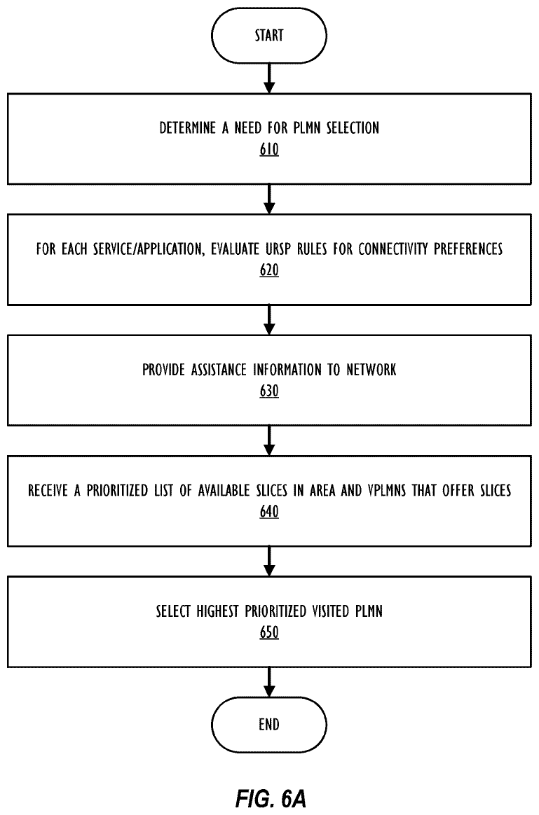

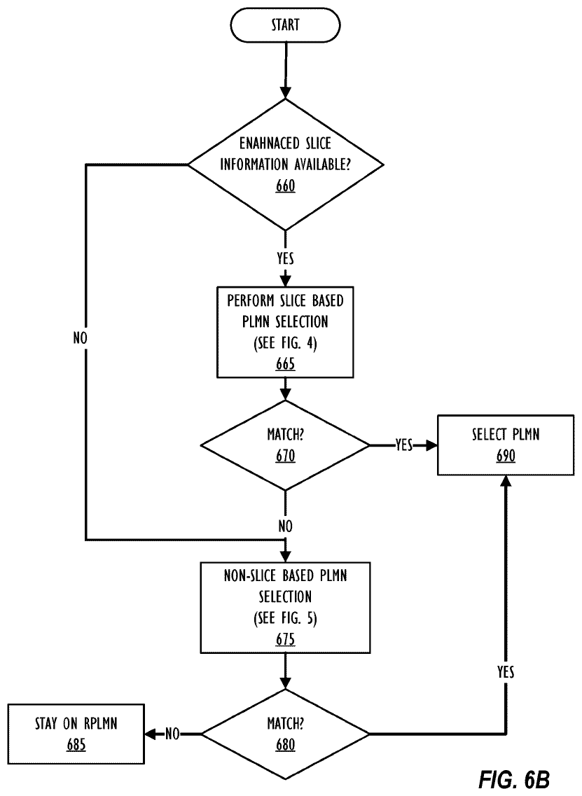

If a prioritized list of available PLMNs for each slice is not available (NO in Step 420), the process proceeds to FIG. 4B. In such scenarios, the HPLMN may not provide a prioritized list of VPLMNs. In Step 422 of FIG. 4B, a prioritized list of PLMNs for each slice is created. This prioritized list may be created similarly to a non-slice-based PLMN selection procedure, for example as demonstrated in FIG. 5. In Step 424, the UE selects the highest priority PLMN for the most preferred UE slice or set of slices.

If enhanced slice information is not available on the USIM or ME, the UE performs a non-slice-based PLMN selection. In other words, if enhanced slice information is available, the slice-based PLMN selection takes precedence over a legacy PLMN selection, or a non-slice-based PLMN selection, in accordance with embodiments disclosed herein.

FIG. 5 illustrates a method for a non-slice-based PLMN selection, according to some aspects. In such selections, a UE may select the last-registered PLMN (RPLMN). As a HPLMN controlled option, a UE may try to select an enhanced-HPLMN (E-HPLMN). The steps of FIG. 5 may be performed in the order presented, to establish a priority in the selection procedure. However, one of ordinary skill in the art will appreciate that embodiments described herein may not be so limited.

In Step 510, the UE may select the HPLMN if there is no E-HPLMN available. If there is no HPLMN (or E-HPLMN) is available, in Step 520, the UE may select a PLMN/Access technology in a “User Controlled PLMN Selector with Access Technology” data file. The “User Controlled PLMN Selector with Access Technology” file may be stored on SIM of the UE. The selection of Step 520 may be made in a priority order presented in the data file.

If Step 520 is unsuccessful, in Step 530, the UE may select a PLMN/Access technology in a “Operator Controlled PLMN Selector with Access Technology” data file. Similar to Step 520, the “Operator Controlled PLMN Selector with Access Technology” file may be stored on SIM of the UE, or otherwise on the UE device. The selection of Step 530 may be made in a priority order presented in the data file.

If the previous steps are unsuccessful, the UE may select a PLMN/Access Technology with a high quality signal in Step 540. This selection may be made in a random order of the available highest quality signals established in Access Stratum protocols. If Step 540 is unsuccessful, in Step 550, a PLMN/Access technology may be selected in the order of decreasing signal quality.

In accordance with embodiments disclosed herein, when considering PLMN selection associated with different applications, a Policy Control Function (PCF) establishes a prioritized list of URSP rules. The URSP includes the rule precedents, traffic descriptors (e.g., IP descriptors, Data Network Names (DNNs), connection capabilities, etc.), and route selection descriptors (e.g., S-NSSAls, Secession and Service Continuity (SSC) mode, preferred access, etc.). The URSP rules may be pre-provisioned in a UE by the HPLMN, or during registration of the UE. The URSP rules may be used to determine a connectivity preference for an application, such as the DNN of a streaming service and a slice for streaming.

Under some roaming scenarios, the desired slice may not be available in the current VPLMN, but available in another VPLMN. Based on the URSP rule precedence, a UE may determine the preferred order of connectivity alternatives where the highest URSP rule precedence corresponds to the highest preference of a connectivity alternative. Accordingly, a URSP rule evaluation can result in a set of slices for a service/application. A UE may assess the active services/applications and apply the URSP rules to obtain a set of slices needed at any given time in accordance with embodiments herein. Thus, the UE may look for slices in another VPLMN when UE is roaming.

FIGS. 6A and 6B describe methods for PLMN selection, according to some aspects. FIG. 6A illustrates a general method for PLMN selection in accordance with embodiments disclosed herein. In FIG. 6A, the need for PLMN selection is determined in Step 610. In some embodiments, PLMN selection may occur upon powering up the UE or during a recovery from a loss of connection or network. In some embodiments disclosed herein, the UE may trigger a slice-based PLMN selection when the UE needs a service (or application) on a new or different slice than that of a current slice. The trigger may be application driven in some embodiments. The trigger may also be determined whenever specific Protocol Data Unit (PDU) sessions are activated by the UE. Such triggers may be initiated based on a lack of coverage according to UE implementation.

The PLMN selection may also be triggered periodically or based on a timer. In some embodiments, the UE may define a separate timer T_slice to trigger periodic slice-based PLMN selection. The timer may be different than a standard periodic PLMN search timer. The values of such timers may be configured by the HPLMN and/or provided in a USIM.

In Step 620, the URSP rules for connectivity preferences are evaluated for each service or application. As previously noted, a UE may assess the active services/applications and apply the URSP rules to obtain a set of slices needed at any given time. For example, a DNN and a slice for streaming from the DNN may be determined.

In Step 630, assistance information may be provided to the network. The assistance information may include a list of desired slices (e.g., S-NSSAIs) for the services/applications and/or properties associated with the slices. Such a list may be provided to the network in an order of desired priority and may also indicate an interest in multiple slices. The assistance information may also include other relevant information, such as signal qualities, TA or location information, UE Assistance Information (UAI), or other information that may facilitate the selection of a PLMN by a UE In Step 640, a prioritized list of available slices in the area and VPLMNs that offer slices may be received from the HPLMN. The prioritized list of available slices may be supplied from the network via the HPLMN. Such a list provided by the network may, or may not, consider the assistance information of Step 630. The list of slices may include the slices that are available in the registration area and a list for each slice of preferred VPLMNs that support that slice. The VPLMNs for each slice may be in a prioritized order based on the HPLMN policies and the UE's subscription. In accordance with embodiments, if there are TAs in a registration area of a VPLMN over which a slice is not supported, the particular VPLMN may be assigned a lower priority.

In a 5G environment, the enhanced slice information may be provisioned onto the UE using a Non-Access Stratum (NAS) Steering of Roaming (SoR) procedure in accordance with embodiments. The enhanced slice information may be stored in the USIM in a data file, or elsewhere in the ME. The enhanced slice information may be updated using a SIM Toolkit that triggers a SIM Refresh command to change contents of SIM elementary files.

One of ordinary skill in the art will appreciate that the exchange of information between the network and a device described in Steps 630 and 640 is not limited to any particular order and may occur at different points in time in a scheduled or as-needed basis. It is further noted that Step 630 may be optional, as a device may select an PLMN based on information derived from the network without sharing assistance information.

In embodiments where the UE does not provide assistance information to network, the HPLMN may provide a generalized list of available slices in an area and the VPLMNs supporting them in a prioritized order. The UE may then conduct a PLMN search based on the active apps, URSP rule precedence, and connectivity preference. The UE may then apply this information to the generalized information available from network.

In Step 650, the highest prioritized visited PLMN may be selected for the services/applications. As noted herein, such a selection may be dependent on HPLMN policies, URSP rules, VPLMN availability, signal quality, location, etc.

FIG. 6B illustrates another method of selecting a PLMN in accordance with embodiments disclosed herein. FIG. 6B may be started upon powering up the UE, during recovery, or triggered based on a timer or need, analogous to that described with respect to Step 610 of FIG. 6A. In Step 660, it is determined if enhanced slice information is available. The enhanced slice information may be present in the USIM or elsewhere located on the ME.

If the enhanced slice information is not available (NO in Step 660), the process may proceed to a non-slice-based PLMN selection shown in Step 675. For example, steps similar to FIG. 5 may be performed to select an appropriate PLMN. That is, in embodiments disclosed herein, the process may revert to a non-slice-based or legacy PLMN selection. In some environments, such as an Evolved Packet System (EPS), a UE may not be able to receive enhanced slice information. Thus, if a UE is connected to legacy environments, the UE may use a non-slice-based PLMN selection or legacy procedure in accordance with embodiments disclosed herein.

If the enhanced slice information is available (YES in Step 660), the process proceeds to a slice-based PLMN selection, for example as demonstrated in FIG. 4, in Step 665. In Step 670, it is determined if there is a match between the slice-based PLMN selection and the available slices. If there is a match (YES in Step 670), the matched PLMN is selected in Step 690.

If the sliced based PLMN selection based on the enhanced slice information does not result in a match (NO is Step 670), the process proceeds to Step 675, where a non-slice-based PLMN selection is performed. For example, the non-slice-based PLMN selection may be performed in a manner analogous to ordered steps shown in FIG. 5. The non-slice-based PLMN selection may also be performed in accordance with legacy procedures. That is, in embodiments disclosed herein, if a UE is unable to select a VPLMN based on the enhanced slice information or if the registration fails for some reason on newly selected VPLMN, the process may revert to a non-slice-based or legacy PLMN connection.

In Step 680, it is determined if there is a match between a PLMN determined in Step 675 and an available PLMN. If there is a match (YES in Step 680), the result of the match is selected as the PLMN in Step 690.

Recall, embodiments associated with FIG. 6B may be triggered based on a timer or a particular need. In some embodiments, the process of FIG. 6B may occur while registered to a PLMN, i.e., connected to the RPLMN. In such embodiments, as part of the matching conducted in Steps 670 and 680, the matching may consider the priority and desirability of obtaining a match in view of the current RPLMN. If there is not a match (NO in Step 680) or the match is not more desirable than a currently connected PLMN, the UE may elect to stay on the current RPLMN in Step 685.

In some embodiments, if the enhanced slice information is available (YES in Step 660) and no desirable match is obtained (NO in Step 670), the process may proceed directly from Step 670 to Step 685. In other words, in some embodiments, the process may omit Steps 675 and 680. These embodiments would skip a non-slice-based PLMN selection consideration (or any legacy considerations) and choose to remain on the current RPLMN (or slice of the current RPLMN).

As indicated above, the enhanced slice information may be stored in the USIM in accordance with embodiments. In some embodiments, the USIM may also store location (e.g., location area identity, tracking area) where the corresponding enhanced slice information may be applicable. The enhanced slice information may be stored in a new service file, e.g., an Elementary File (EF) that is used to indicate what services are available. For example, the information may be stored in the Service Contents of the USIM as a new EF directed to Steering of Roaming-Enhanced Slice Information (SoR-ESI) in the USIM.

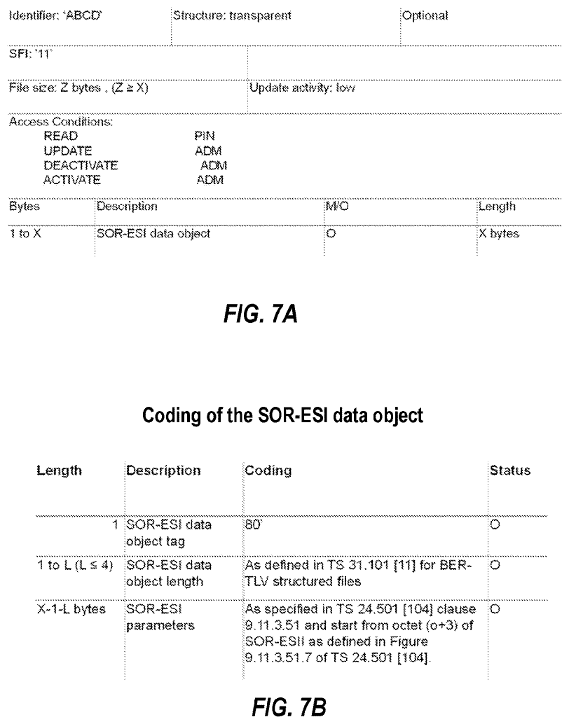

FIGS. 7A and 7B provide examples of how the enhanced slice information may be organized on a USIM in accordance with embodiments. FIG. 7B is presented with reference to existing standards with respect to the “Coding of the SOR-ESI data object”

In the example above, the enhanced slice information is associated with the SoR considerations. Continuing the example with respect to current standards, a “Spare” bit of a SoR container may be adopted for the ESI. That is, an available bit in the SoR container may be used to indicate the ESI capabilities. If the ESI bit is set, the UE may receive the S-NSSAIs and the supported PLMN list.

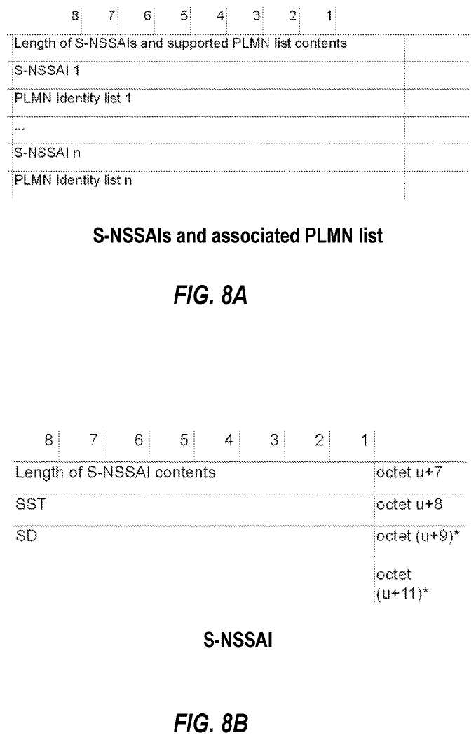

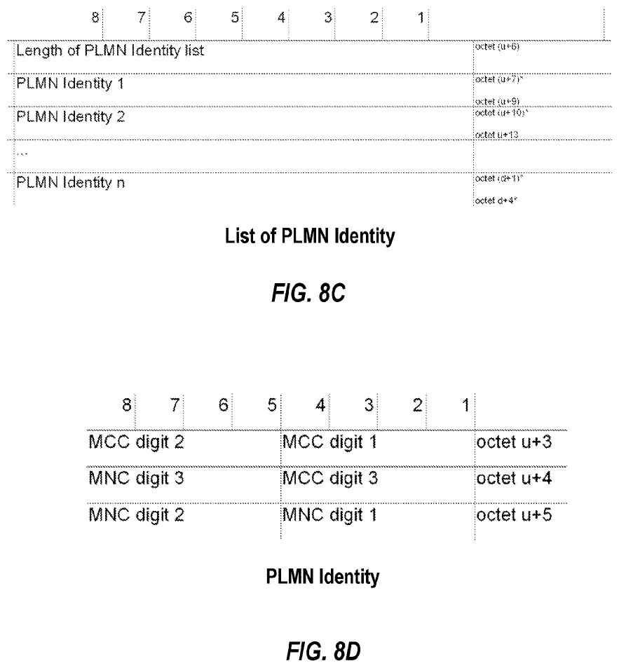

FIGS. 8A through 8D illustrate an example of how such SoR-ESI information may be stored/presented to the UE, according to some aspects. FIG. 8A is an example of a S-NSSAIs and the supported PLMN list. FIG. 8A illustrates a list that includes the slices (S-NSSAI-1 . . . S-NSSAI-n). For each slice, FIG. 8A identifies the PLMN elements that may be used for the slice. The list demonstrated in FIG. 8A may be presented in a prioritized order in accordance with embodiments.

FIGS. 8B and 8C further define the S-NSSAIs and PLMN identities demonstrated in FIG. 8A, respectively, in a manner consistent with current standards. FIG. 8D further defines the PLMN identities with respect to a Mobile Country Codes (MCCs) and Mobile Network Codes (MNCs) in a manner consistent with current standards.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102, Network 100) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1.-3. (canceled)

4. A method for slice-based Public Land Mobile Network (PLMN) selection in a roaming scenario, the method comprising:
obtaining enhanced slice information from a Home-PLMN (HPLMN) comprising available slices in an area from a visited network;
generating a prioritized list of the available slices;
determining if a prioritized list of available PLMNs is available for each slice; and
when the prioritized list of available PLMNs is available:
selecting a highest priority PLMN of the available PLMNs for a most preferred slice or slices of the available slices; and
performing wireless communication using the most preferred slice or slices of the highest priority PLMN;
when the prioritized list of available PLMNs is not available:
generating a prioritized list of PLMNs for each available slice;
selecting a highest priority PLMN from the prioritized list of PLMNs for a most preferred slice or slices from the prioritized list of the available slices; and
performing wireless communication using the most preferred slice of the highest priority PLMN.

5. The method of claim 4, wherein selecting the highest priority PLMN is based on multiple slices to be used simultaneously.

6. The method according to claim 4, wherein generating the prioritized list of the available slices is based on active applications and a UE Route Selection Policy (URSP).

7. The method according to claim 4, wherein the prioritized list of PLMNs for each available slice comprises at least one of the following when enhanced slice information is not available from the HPLMN:
a home PLMN (HPLMN);
an equivalent HPLMN (E-HPLMN);
a PLMN from a “User Controlled PLMN Selector with Access Technology” data file;
a PLMN from a “Operator Controlled PLMN Selector with Access Technology” data file; and
a PLMN with a high signal quality.

8. The method according to claim 4, further comprising: transmitting assistance information to the network.

9. The method of claim 8, wherein the assistance information comprises:
a prioritized list of desired slices.

10. The method of claim 9, wherein the prioritized list indicates a desire for accessing more than one slice at a time.

11. The method of claim 9, where the prioritized list of desired slices is based on a UE Route Selection Policy (URSP) and an active application.

12. (canceled)

13. The method of claim 4, further comprising:
receiving the enhanced slice information from the network,
wherein the enhanced slice information comprises:
a list of Single-Network Slice Selection Assistance Information (S-NSSAIs) that uniquely identify a network slice available in a registration area, and
for each S-NSSAI a preferred list of Visiting-PLMNs (VPLMNs) that support said slice.

14. (canceled)

15. The method of claim 4, further comprising:
receiving the enhanced slice information from the network,
wherein the preferred list of VPLMNs is prioritized based on known areas of a VPLMN coverage area in which the S-NSSAI is not supported.

16. The method of claim 4, further comprising:
receiving the enhanced slice information from the network,
wherein the enhanced slice information is received via a Non-Access Stratum (NAS) Steering of Roaming (SoR) procedure.

17. The method of claim 4, further comprising:
receiving the enhanced slice information from the network,
wherein the enhanced slice information is stored on a Universal Subscriber Identity Module (USIM) of a wireless device.

18. (canceled)

19. The method of claim 4, wherein generating the prioritized list of the available slices is triggered by a wireless device desire for a new service not available on a current slice.

20. (canceled)

21. (canceled)

22. A wireless device comprising:
a receiver;
a transmitter;
at least one interface; and
a processor configured to cause the wireless device to:
obtain enhanced slice information from a Home-PLMN (HPLMN) comprising available slices in an area from a visited network;
generate a prioritized list of the available slices;
determine if a prioritized list of available PLMNs is available for each slice; and
when the prioritized list of available PLMNs is available:
select a highest priority PLMN of the available PLMNs for a most preferred slice or slices of the available slices; and
perform wireless communication using the most preferred slice or slices of the highest priority PLMN;
when the prioritized list of available PLMNs is not available:
generate a prioritized list of PLMNs for each available slice;
select a highest priority PLMN from the prioritized list of PLMNs for a most preferred slice or slices from the prioritized list of the available slices; and
perform wireless communication using the most preferred slice of the highest priority PLMN.

23. (canceled)

24. The wireless device of claim 22, wherein selecting the highest priority PLMN is based on multiple slices to be used simultaneously.

25. The wireless device of claim 22, wherein the processor is further configured to cause the wireless device to:
transmit assistance information to the network.

26. The wireless device of claim 25, wherein the assistance information comprises:
a prioritized list of desired slices.

27. (canceled)

28. A baseband processor configured to cause a wireless device to:
obtain enhanced slice information from a Home-PLMN (HPLMN) comprising available slices in an area from a visited network;
generate a prioritized list of the available slices;
determine if a prioritized list of available PLMNs is available for each slice; and
when the prioritized list of available PLMNs is available:
select a highest priority PLMN of the available PLMNs for a most preferred slice or slices of the available slices; and
perform wireless communication using the most preferred slice or slices of the highest priority PLMN;
when the prioritized list of available PLMNs is not available:
generate a prioritized list of PLMNs for each available slice;
select a highest priority PLMN from the prioritized list of PLMNs for a most preferred slice or slices from the prioritized list of the available slices; and
perform wireless communication using the most preferred slice of the highest priority PLMN.

29. The baseband processor of claim 28, wherein selecting the highest priority PLMN is based on multiple slices to be used simultaneously.

30. (canceled)

31. The baseband processor of claim 30, wherein the assistance information comprises:
a prioritized list of desired slices.

32. (canceled)
